(19) United States
(12) Patent Application Publication
(10) Pub. No.: US 2004/0233200 A1
(43) Pub. Date: Nov. 25, 2004

(54) Systems and methods for interactive multimedia presentation and marketing

(76) Inventor: Ronald M. Karren, Orem, UT (US)

Correspondence Address: WORKMAN NYDEGGER (F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 10/444,672

(22) Filed: May 23, 2003

(51) Int. Cl. G06T 13/00; G09G 5/00

(52) U.S. Cl. 345/473; 345/629

(57) ABSTRACT

Systems and methods for providing presentational and marketing tools that closely mimic television by transitioning a computer monitor into more of a television-type medium. The presentational and marketing tool is based on the creation of a transparent background of a video clip for display on a computer screen. This creates the illusion that the on-screen personality giving the presentation is not confined to a video box typically seen in computer video clips. The presenter appears to move around the computer screen and interact with various items on the screen. The viewer can be guided back and forth between an educational setting and web sites on the Internet several times throughout a presentation on a particular topic. After providing education through a multimedia presentation, a variety of offers can be presented and transacted immediately over the Internet. Several marketing models and techniques have been specifically developed for and in conjunction with this interactive multimedia format.

### BACKGROUND OF THE INVENTION

1. Field of the Invention

The present invention is generally related to computer-based multimedia applications. More particularly, the present invention relates to systems and methods that provide interactive presentational and marketing tools that closely mimic television by transitioning a computer monitor into more of a television-type medium.

2. Background Technology

Since the advent of television, it is generally accepted that, depending on programming content, television programs can hold viewer attention span for hours in one sitting. As a result, marketers and educators have utilized the appeal of television to promote many products and services through the use of videos played on a television or by infomercials. These promotional techniques require the viewer to go from the television to a telephone in order to order a product offered for sale. Because of this media changing requirement, both time and space are increased between the pitch of a product and the close of the transaction, resulting in many lost sales because of the necessary change between viewing media and purchasing media.

With the proliferation of home computers and the internet, marketers and educators have tried to exploit these media for promoting products and services. However, selling, training, or educating on computer media including over the Internet has been extremely limited because of the inability to portray people in a realistic setting. Because filming people requires video, and the very nature of video entails large, cumbersome files, computers struggle to process these files. Additionally, educational or promotional material on the computer has been limited to lengthy pages of “read-and-click” material, or to the small, confined “talking head” within a video box.

With the inherently large file sizes of video clips, the use of video on a computer is extremely limited. Since, the use of video on the computer requires more processing power than most computers have, the video must be produced in shorter segments, and it must be drastically reduced in size. The average computable size of video is approximately 320×240 pixels (approx. 3″×4″). Because of this small size, the presentations on the video are very limited and the attention span of the average viewer is heavily taxed. With such limitations, the computer-based multimedia industry has been unable to hold the attention of the end-user for more than a few minutes. This has been a contributing factor to the depression seen in the dot-com industry.

### SUMMARY OF THE INVENTION

The present invention relates to systems and methods that provide a unique presentational and marketing tool that closely mimics television by transitioning a computer monitor into more of a television-type medium. As a result, there are several marketing techniques that have been developed, which are unique to and dependent upon this inventive multimedia format.

The presentational and marketing tool is based on the creation through green/blue screen technology of a transparent background of a video clip for display on a computer monitor. The background of the video clip is made to match the background of the computer screen, creating the perception that the presenter is free to walk the entire computer screen, as opposed to being confined to the set area of a typical computer video box. The presenter appears to walk around the screen while interacting with pictures, charts, graphs, and buttons, which take the viewer to different locations in the presentation or back and forth between the presentation and a related web site on the Internet, with only the click of a mouse button.

While the on-screen personality is actually subject to a video box, the video background is created to match the color of the computer screen, thereby presenting the illusion that there is no confinement to a video box. With the background color of the computer screen having the same color as the video clip background, the actual video box cannot be detected on the computer screen by the viewer. The video clips are positioned on different parts of the computer screen to produce the illusion that the on-screen personality is moving freely on the screen.

Accordingly, in one aspect of the invention, a method for displaying a multimedia presentation on a computer screen includes producing a plurality of video clips of one or more persons, with the video clips having a selected background. The background of the video clips is matched with a background of the computer screen, and the video clips are displayed in a predetermined order at various locations on the computer screen to create the perception that the one or more persons is free to move about the computer screen without being confined to a set area on the computer screen.

In another aspect of the invention, a computer product for displaying a multimedia presentation on a computer screen includes a computer readable medium carrying computer-executable instructions for displaying the multimedia presentation. The computer-executable instructions comprise a program module for displaying a plurality of video clips as described previously. In a further aspect of the invention, a computer system comprises a computer-readable medium carrying computer-executable instructions for displaying a multimedia presentation, including the plurality of video clips discussed above.

The presentational tool of the invention allows for collapsing the time and space gap between sales pitch and purchase found in most marketing schemes. A method of marketing one or more products or services according to the invention comprises providing a computer product for displaying a multimedia presentation on a computer screen that informs a viewer about the one or more products or services. The viewer is prompted during the presentation to connect to one or more Internet web sites to obtain further information or to purchase the one or more products or services. For example, the viewer can be guided back and forth between an educational setting and one or more sites on the Internet several times throughout a workshop presentation on a particular topic. After providing education to a target audience through the presentation, a variety of offers can be presented and such offers can be transacted immediately over the Internet by providing a link to a related web site. Both the pitch and the opportunity for purchase are provided on the same media so that no change in media use (“media hopping”) is necessary to transact the sale.

In one marketing technique of the invention, a method of recruiting one or more persons to join an organization comprises providing a multimedia presentation for display on a computer screen that informs a viewer about the organization. The viewer is prompted during the presentation to connect to an Internet web site of the organization in order to join the organization. The viewer is instructed to enter a sponsor identification code as part of a membership sign-up process at the web site to join the organization. The membership of the viewer is then placed in the pedigree of a sponsor having an identification code that corresponds to the identification code that was entered by the viewer.

In another marketing technique of the invention, a method of generating one or more leads for a service-based organization comprises providing a multimedia presentation that informs a viewer about a selected topic. The viewer is prompted during the presentation to connect to a web site in order to obtain an analysis or evaluation, and the viewer is instructed to enter information as part of a case profile at the web site to generate a lead.

In a further aspect of the invention, a method of marketing to interest-specific communities includes providing a multimedia presentation that informs an end user about selected topic of interest. The end user is prompted during the presentation to connect to one or more Internet web sites to obtain further information or to order one or more products related to the topic. If one or more products are ordered, information related to the product order is transmitted to one or more product suppliers for shipment of the product order, with revenue from the product order being sent to an intermediary entity that retains a commission for the product order.

In another aspect of the invention, a method of campaigning for a political candidate includes providing a computer product for displaying a multimedia presentation that educates a viewer about the candidate and other selected topics. The viewer is prompted during the presentation to access one or more web sites to obtain further information on a selected topic.

These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a schematic depiction of a computer monitor with a video clip displayed thereon according to the present invention, with the dotted line representing the transparent border of the video clip;

FIG. 2 is a schematic depiction of a computer monitor with three video clips displayed thereon in a linear and consecutive manner according to the present invention;

FIG. 3 is a schematic depiction of a computer monitor showing video clips of stage-left and stage-right entries of an on-screen presenter according to the present invention;

FIG. 4 is a schematic depiction of a computer monitor showing a video clip of an on-screen presenter interacting with various graphical items according to the present invention;

FIG. 5 is a flow diagram of the method for producing an interactive presentation using video clips on a computer monitor according to the present invention;

FIG. 6 is a schematic diagram of an interactive recruiting method of the present invention;

FIG. 7 is a schematic diagram of an interactive lead-generation method of sent invention;

FIG. 8 is a schematic diagram of an interactive subscription technique of the invention; and

FIG. 9 is a schematic diagram of a campaign method of the present on.

### DETAILED DESCRIPTION OF THE INVENTION

The present invention is directed to systems and methods that provide a unique presentational and marketing tool that closely mimics television by transitioning a computer monitor into more of a television-type medium. Generally, this is accomplished by techniques in which digital videos are created for the purpose of enabling the image of a person to move around a computer screen, which gives the appearance that the on-screen presenter is not confined to a video box on the screen. Through cinematographic techniques and the strategic placement of video clips on the computer screen, the on-screen presenter appears to be walking around the entire screen, similar to a television program.

Besides quality programming, maintaining viewer attention span on the computer is a function of presentation size, and media format. The techniques of the invention for creating a television-type medium on a computer screen enable marketers and educators to maintain viewer attention span equivalent to the attention span maintained by television programs. In addition, various marketing techniques have been developed based on this unique interactive multimedia format.

Various aspects of the present invention are discussed in further detail hereafter.

1. Interactive Multimedia Format

The presentational and marketing tool of the invention is based on the creation through green/blue screen technology of a transparent background of a video clip for display on a computer monitor. This creates the illusion that the on-screen personality giving the presentation is not confined to a video box typically seen in computer video clips. The presenter in the video clip appears to move around the computer screen and interact with various objects on the screen. The presenter can walk around the screen while interacting with pictures, charts, graphs, and buttons, which take the viewer to different locations in the presentation or back and forth between the presentation and a related web site on the Internet, all with just the click of a computer mouse button.

While the on-screen personality is actually subject to a video box, the video background is created to match the color of the computer screen, thereby creating the illusion that there is no confinement to a video box. With the background of the screen of the computer monitor having the same color as the video clip background, the actual video box cannot be detected on the screen by the viewer. The video clips are positioned on different parts of the screen to produce the illusion that the on-screen personality is moving freely on the screen. The duration of each video clip is generally kept at about 3 minutes or less, with the entire productions averaging 60 to 100 total video clips. Various aspects of producing the video clips are discussed hereafter.

A. Video Clips

Initially, the size of the video used to produce the clips is reduced to produce a functional file size, and to reduce the body size of the presenter so that the image of he or she appears to walk around the computer screen, such as one would see on a television screen. The average size of the video clips used to achieve this illusion is 320×240 pixels.

Next, the videos are shot using standard cinematographic techniques, such as with green or blue screen technology, to enable the removal of the background of the video such that everything around the perimeter of the on-screen presenter is removed. This allows the background color of the video clip to be matched to the background color of the area around the video clip. By matching the video clip background to the presentation background, it now appears that the on-screen presenter is no longer confined to the smaller video box, but is free to move around the entire computer screen.

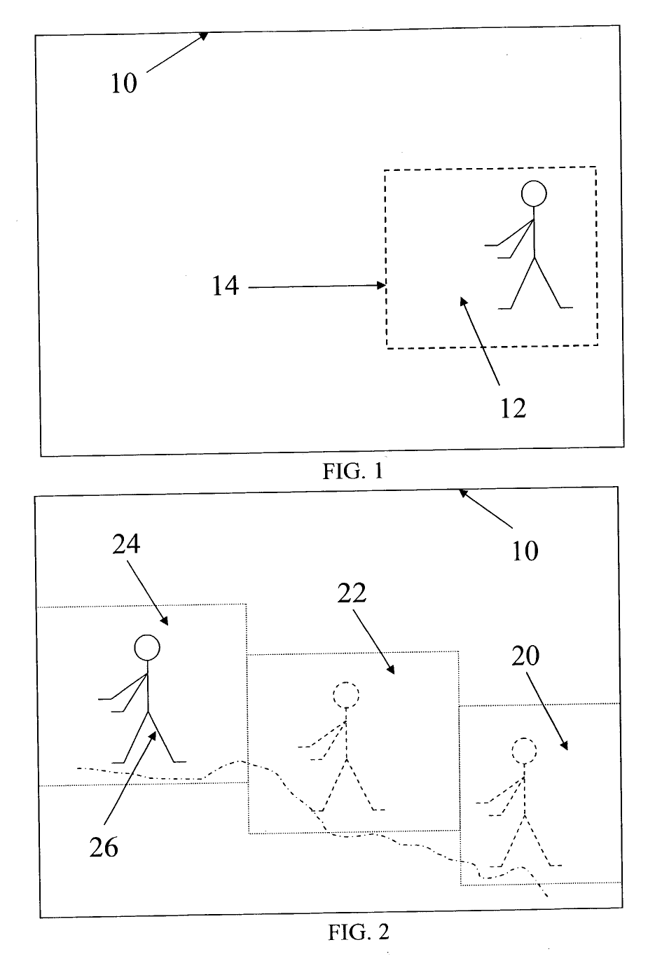

This technique of the present invention is depicted schematically in FIGS. 1-3. FIG. 1 shows a computer screen 10 with a video clip 12 displayed thereon. A dotted line 14 around video clip 12 represents the transparent perimeter of the video box in which video clip 12 is played, and shows the overall size of video clip 12 in comparison to computer screen 10.

FIG. 2 depicts three video clips 20, 22, and 24, which appear on computer screen 10 in a linear and consecutive manner, starting with clip 20 and ending with clip 24. By strategically placing the clips in such a linear and consecutive manner, it appears that an on-screen personality 26 walks from one side of computer screen 10 to the other, thereby giving the perception to the viewer that the on-screen personality is not confined to the video box.

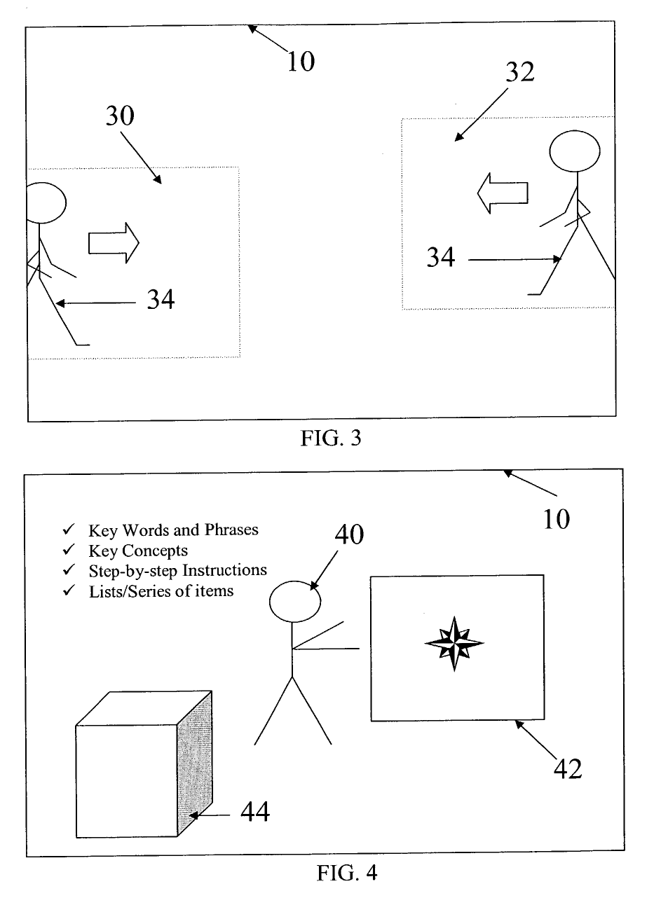

Another important aspect of background-negated video clip placement is locating the video clip next to the left and right borders of the presentation boundary, and having the on-screen personality walk onto the screen from the respective side. For example, FIG. 3 shows video clips 30 and 32 depicting stage-left and stage-right entries on computer screen 10 of an on-screen personality 34. By using video clips of stage-left and stage-right entries, it appears to the viewer that the entire computer screen is the stage on which the on-screen personality is free to move. Such video clips are placed precisely on the edge (pixel zero) of the on-screen stage to provide a stage-left or a stage-right entry of the on-screen personality. When played, it appears as though the on-screen personality is walking onto the screen, free of any video box confinement.

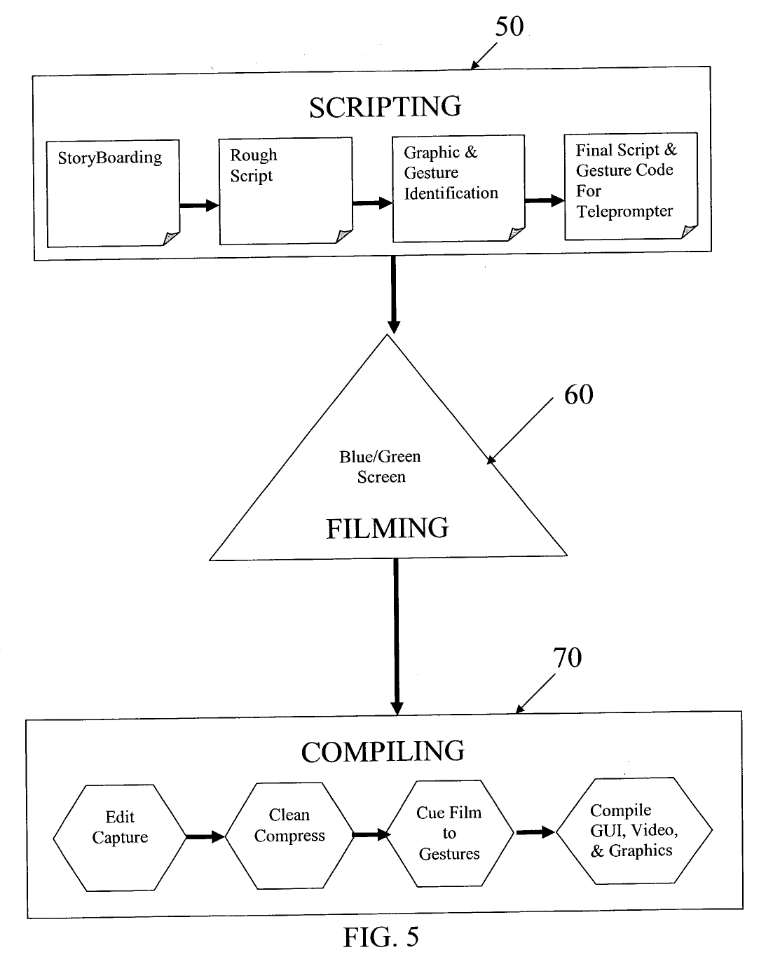

Through strategic scripting and filming, the on-screen presenter is cued to point or gesture in various directions (as scripted and choreographed). The video clips are then placed in various locations on the computer screen, giving the appearance that the on-screen presenter is actually walking around and interacting with various graphical items. Such graphical items may include drawings, photographs, animations, charts, graphs, buttons, icons, textual items such as key words or phrases, key concepts, step-by-step instructions, lists or series of items, other videos, etc. For example, FIG. 4 schematically depicts an on-screen presenter 40 on computer screen 10 interacting with textual items and graphics 42, 44.

The audio track of each video clip is digitally “cued” so that when the presenter says a cued key word, a graphic or bullet point (followed by text) appears in exact synchronicity as the word is spoken. In this manner, when the on-screen personality points to a graphic element (and says the digitally cued word) the graphic appears at his fingertips, creating the visual features and attention-maintaining phenomenon that rivals what television has to offer.

In addition to the techniques discussed above, the video clips can be produced with a number of other filming techniques such as pans, fade-ins, fade-outs, walk-ons, walk-offs, cross-dissolves, and morphs, which enhance the change-up and variation of shots and thereby more closely mimic what television delivers and much more. Through the green screen or blue-screen formatting of video clips, and through the strategic (x/y axis) placement of these video clips within the production, and with specific choreographed techniques in the filming process, the computer monitor takes on the appearance, and the attention-maintaining attributes of television. Once the clips are filmed, edited, and the green/blue screen is removed, they are imported and placed on the screen in the desired positions via conventional third-party multi-media presentation software.

B. Production Method

In general, a method for producing an interactive multimedia presentation for display on a computer screen according to the invention comprises making a plurality of video clips of one or more persons as described previously, with the video clips having a selected background. The background of the video clips is matched with a background of the computer screen. The video clips are then compiled with one or more graphical items for display on the computer screen in a presentation such that the video clips are positioned at various locations on the computer screen to create the perception that the one or more persons is free to move about the entire computer screen and interact with the one or more graphical items without being confined to a set area on the computer screen.

More particularly, the method for producing an interactive presentation using the video clips described previously includes three different phases: scripting, filming, and compilation, which are discussed in further detail hereafter. A process flow diagram of this method is depicted in FIG. 5. The scripting phase 50 is carried out initially, and includes storyboarding, writing the rough script, identifying graphics and gestures, and preparing the final script and gesture codes for use on a teleprompter. The scripting phase is also used to identify the angles and camera techniques of each clip. Subject to each clip are key words, graphics and any animations, which are identified via color coding, so that the on-screen personality knows how, when, and where to point or gesture. It is in the scripting phase that graphics and/or animations are identified and their gathering started.

In the filming phase 60, the filming of the presenter transpires, for the most part, on a green or blue screen, using traditional television and cinematography techniques as discussed previously. When a traditional (non-green/blue screened) video clip is implemented into a production, it is generally done in conjunction with a green/blue screened presenter who introduces the subject matter of the traditional video clip. The term “filming” as used herein refers to use of any type of recordable media to capture moving images and sound, such as traditional film, digital or analog video tape, recordable optical media, and the like.

The compiling phase 70 includes four major steps: edit and capture, clean and compress, cuing film to gestures, and compiling graphical user interface (GUI), video, and graphics. Commercial editing software can be used in the editing process, with the shots of choice being captured, re-sized to fit the presentation pixels, and the green (or blue) background is dropped from the video clips. In addition, any sound anomalies are normalized during this phase. The edited clips are then run through commercial cleaning/compressing software to reduce the file size of the video. The resulting size is typically about one-tenth the original file size. Additionally, the cleaner function of the software sharpens and provides more depth to the colors and tones of the video content.

Using the color-coded script, the audio tracks (of the video clip) are cued so that in the compilation process, the graphical items can be synchronized to the audio track. This function is important in producing the “out-of-the-box” illusion of the video clip. When the on-screen personality reads a specific color-coded word on the teleprompter, he or she will either gesture right, left, above or below. When that specific word is cued on the sound track, a certain graphical item (text, picture, button, animation, etc.) is placed in the precise location where the on-screen personality is gesturing. This produces the illusion that the on-screen personality is walking around and interacting with objects across the entire computer screen, rather than being confined to the video box, and that each graphical object is appearing exactly when the presenter gestures in any given direction. By using commercial presentation software, the video clips, cued audio tracks, graphics, sound bytes, GUI, and function buttons are all compiled to bring about a final production.

The final production presentation can then be copied to a computer product for storage, which can be used to display the presentation on a computer screen of any conventional computer. Such a computer product can include a conventional computer readable medium carrying computer-executable instructions for displaying the presentation, such as an optical storage medium. Non-limiting examples of a suitable computer readable medium include a compact disc (CD, CD-ROM, CD-RW, etc.), hereafter referred to as a “CD”, a digital video disc (DVD, DVD-ROM, DVD-RW, etc.), hereafter referred to as a “DVD”, a hard drive or other memory devices, and the like. The computer-executable instructions comprise a program module for displaying the video clips and graphical items as described previously.

The presentation can also be stored in a computer system comprising a computer-readable medium carrying computer-executable instructions for displaying the presentation, including the plurality of video clips and graphical items as discussed above. Such a computer system can include a server computer that stores the presentation, which is accessible by one or more client computers over a computer network such as the Internet. The presentation can be displayed on the client computers through conventional file streaming over the computer network or other conventional techniques, which provide a computer data signal embodied in a carrier wave.

The actual format of a final production contains some specific patterned traits. The GUI usually includes two panels arranged in a header, footer, and/or two side panels. The background of the computer screen is generally white and the video clip backgrounds are also white, although other matching colors can be used, so that the actual video box cannot be detected. A documents or resources module can be employed that contains printable or downloadable documents, such as the script of the main body of the presentation, pertinent support material to the main body of the workshop, or other relevant charts, graphs, photos, etc. The presentations can also contain such navigational features as fast forward, rewind, pause, or play that allow the viewer to navigate through the presentation clip by clip.

A unique feature of the multimedia format of the invention is the provision of a program module including a static list of one or more questions for display on the computer screen and a corresponding video clip of a person giving the answer for each question. When a question is selected by the viewer from the list of questions, the video clip of the person appears on the computer screen to give the answer. For example, this can be provided in a frequently-asked-questions (FAQs) module, which is formatted with a static list of questions. When the viewer selects a question such as by clicking on the question, the list of questions disappears and is replaced with the on-screen presenter on the computer screen to answer the question that was selected, whereafter the list of questions re-appears.

The multimedia format of the invention can be used to produce educational presentations or workshops that last from a few minutes up to about 2 hours. This permits the viewer to participate in interactive workshops, seminars, or long-distance courses as desired. Seminar or other educational-based entities can produce a workshop or seminar on a particular topic, and distribute it electronically on CD or DVD, allowing marketing to the masses who normally don't attend live seminars or workshops.

2. Marketing Techniques

As a result of the unique multimedia format described previously, there are several marketing techniques that have been developed that depend on this format. In general, these techniques provide increased viewer attention span on computer media while collapsing the time and space gap between sales pitch and purchase found in most marketing schemes. A personal, attention-grabbing presentation takes place on the computer, while the sales transaction can also take place immediately thereon, such as by providing access to an Internet web site to transact the sale. By maintaining the attention span of viewers, marketers are able to pitch products and enable transactions throughout the production.

For example, during a workshop interactive presentation on a particular topic, the viewer is guided back and forth between an educational setting and one or more web sites on the Internet for downloads (or other electronic interaction) relevant to the

workshop subject matter. After providing education to a target audience through the presentation, a variety of offers can be presented and such offers can be transacted immediately over the Internet by providing a link to a related web site. This is done by prompting the viewer to select various buttons in the presentation such that the viewer is taken from the presentation to the Internet and directly to the Uniform Resource Locator (URL) allocated to each button, where the viewer can obtain more information or purchase products via conventional e-commerce. Thus, after the sales pitch is made to the viewer during the presentation, the sales transaction requires neither a phone call nor a media change such as from television to computer. Rather, both the pitch and the opportunity for purchase are provided on the same media so that no change in media is necessary to transact the sale.

Specific marketing applications that can use the unique multimedia format of the invention are described hereafter. While the following discussion and accompanying figures refer to a CD/DVD format for the presentations used in the various marketing methods of the invention, it should be understood that the presentations can be stored on a server computer that is accessible by one or more client computers over a computer network for use in the methods. In such an implementation, the CD/DVD format can be substituted by or supplemented with the capability of providing access to the presentation through a computer network such as the Internet.

A. Recruiting Method

Organizations that depend on recruiting people into their organizations, such as multi-level or network marketing companies, can use the multimedia format of the invention to create productions that are copied onto portable media formats such as CDs, DVDs, or other memory devices for distribution. These productions can use individual modules to tell about the company, the opportunity, the products, and other pertinent details such as the compensation plan, testimonials, frequently-asked-questions, and resources. An important aspect of this marketing technique is to have a static sign-up button on the screen such as a “Join Us”-type button, which connects the viewer to the company's sign-up page on a related Internet web site.

For example, on the main screen of the production, a “Join Us” button (or similar button) can be placed, which if selected, takes the viewer (via the Internet) to an on-line sign-up page where the viewer can sign-up in the organization. Upon reaching the sign-up page, the viewer is asked for the sponsor identification code or number of the individual who gave the viewer the CD/DVD. The viewer is prompted to search for that number either on the label of the CD/DVD, or package (or sleeve) in which the CD/DVD was delivered. The viewer signs-up with that number, wherein the viewer is automatically (and electronically) placed in the “downline” or “pedigree” of the individual who placed the CD/DVD with the viewer, giving the recruiter instant credit for the recruitment.

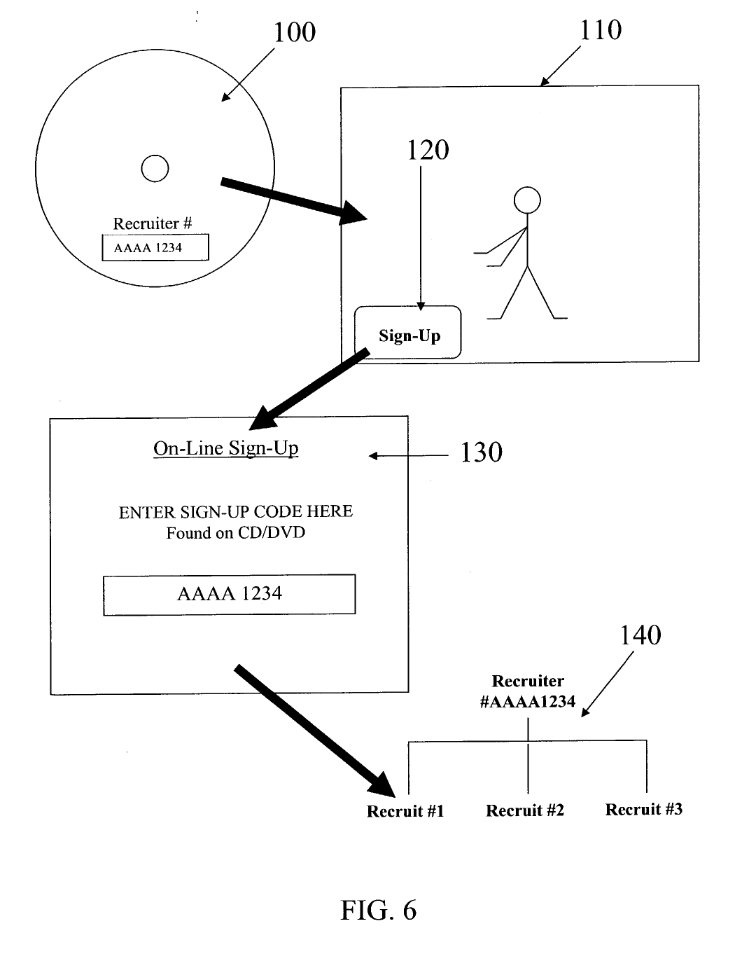

FIG. 6 is a schematic diagram depicting the interactive recruiting method of the present invention. The production content of a memory device 100 such as a recruiting CD/DVD (e.g., in an educational format) is geared to recruit individuals into the organization and can be produced in the manner described previously. The recruiting CD/DVD is priced to enable members of the organization to purchase large quantities, write their recruiter identification code or number on the CD/DVD, and hand them out to potential recruits. Alternatively, memory device 100 can be part of a server computer that can be accessed by an authorized client computer over a computer network such as the Internet for display of the presentation on a computer monitor 110 of the client computer. In such an implementation, the recruiter identification code is given to a potential recruit by the recruiter and the code can be used to provide access to the server computer.

A potential recruit views the content of memory device 100 on computer monitor 110, and throughout the presentation, the viewer is prompted to select a Sign-Up button 120 displayed on the screen, which normally remains static throughout the entire presentation. Selecting the Sign-Up button connects the web browser to a Sign-Up page 130 at the company web site. On the web site Sign Up page, the viewer is instructed to enter the specific code or number as provided on the CD/DVD or as given by the recruiter. The on-line sign-up process requires the potential recruit to enter the code or number written on the CD/DVD (or packaging). Upon entering the number, the on-line process is started and runs in accordance with that particular company's sign-up procedure, and the newly recruited individual is automatically and electronically placed in the recruiter's organization 140.

In this manner, individuals who find it difficult to perform the recruiting process can purchase a professionally produced presentation of the company/opportunity on CD/DVD, write their individual number (e.g., sponsor identification code) on the CD/DVD, pass them out, and receive credit for anyone signing-up who does so with the number.

B. Lead-Generation Method

Another marketing method of the invention provides innovative and unique lead generation and marketing avenues for many service-based industries, with specific applications in the legal, accounting, insurance, financial planning, investment, tax preparation, real estate, and similar service industries. The lead-generation method of the invention is geared to educating the public on specific areas within a broad spectrum of professional services. This method involves the following basic steps: an educational workshop based on the subject at hand, an invitation for a free analysis or evaluation, and the placement/sale of the case file or lead information.

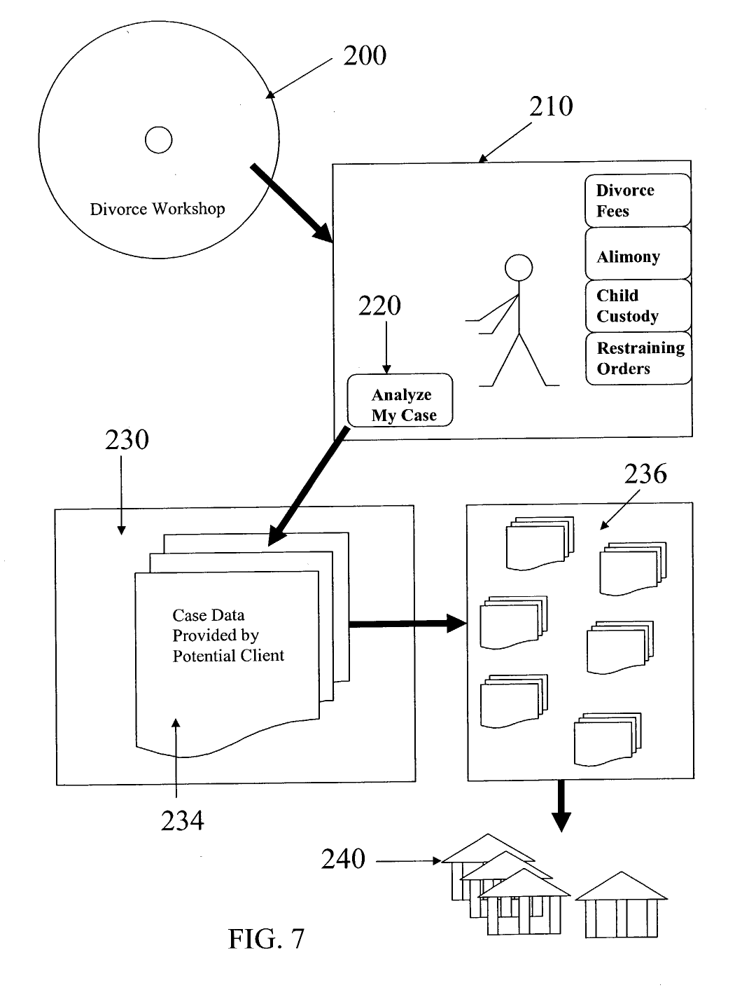

FIG. 7 is a schematic diagram depicting the interactive lead-generation method of the present invention, using the legal industry as an example, with divorce being the subject matter. The content of a workshop CD/DVD 200 can be produced in the manner described previously, and the workshop CD/DVD 200 is marketed to the public. The potential divorcee views the content of CD/DVD 200 on a computer monitor 210, and throughout the presentation is walked through the divorce process by viewing various modules related to fees, alimony, child custody, restraint orders, legal strategies, etc. After educating the viewer on the entire divorce process, the viewer is prompted to click on a free assessment button 220 to have his or her case analyzed. The viewer is taken to a web site 230, wherein he or she enters specific data as provided on an on-line form for a free analysis, which produces a case file lead 234. The case file (or lead) is gathered into a database 236 by the producing firm, or sold to legal firms or to a legal network 240.

In using the lead-generation method of the invention for the real estate industry, the content of a workshop CD/DVD, such as on the home buying or selling process, can be produced in the manner described previously, and the workshop CD/DVD is marketed to the public. The viewer is walked through the various aspects of home buying or selling, and throughout the workshop is cued to click on a free assessment button. The information provided by the viewer is processed on a web site, and the lead is sold to a real estate agent or firm. Similar methods can be employed in various other service-based industries to generate leads.

C. Subscription Technique

In a further marketing technique of the invention, interest-specific workshops are made available to interest-specific communities on a subscription basis such as in monthly issues of CD/DVD workshops. A series of workshops is created and geared to specific industries, such as beauty, crafts, outdoor sports and activities, pet care/training, hobbies, etc. Throughout the individual workshops within the series, various products and/or services are offered to the subscribing viewer, and sales transactions can take place immediately over the Internet via traditional e-commerce methods. The workshops are strategically created in order to interactively guide the viewer back and forth between the workshop and various web sites, creating multiple web site hits per person, per workshop.

In a business system for marketing to interest-specific communities, an intermediary entity has a first contractual relationship with at least one end user. The first contractual relationship includes terms in which the intermediary entity delivers to the end user a computer product for displaying a multimedia presentation about a selected topic in response to receipt of value from the end user such as a subscription fee. The intermediary entity also has at least one supply contractual relationship with at least one supplier entity. The supply contractual relationship includes terms in which the supplier entity provides value to the intermediary entity in response to a product order from the end user. The value provided by the supplier entity can be in the form of a commission based on the product order from the end user. The intermediary entity can also optionally have an ally contractual relationship with at least one ally entity, such as a web site provider. Such an ally contractual relationship includes terms whereby the ally entity delivers value from the intermediary entity to at least one end user, such as access to one or more web sites.

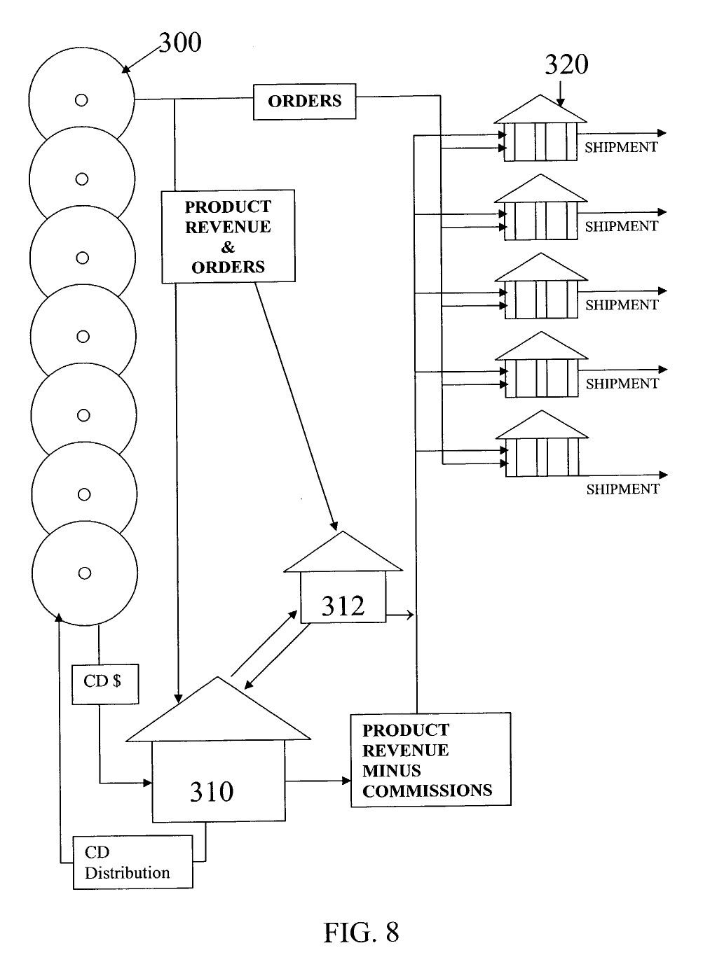

FIG. 8 is a schematic diagram depicting the interactive subscription technique of the present invention. The content of an interest-specific workshop on CD/DVD 300 can be produced in the manner described previously, and the workshop CD/DVD 300 is marketed to interest-specific communities on a subscription basis by intermediary entity 310, which provides front-end subscription revenue to intermediary entity 310. The end user of CD/DVD 300 is guided back and forth between the educational setting of the workshop on CD/DVD 300 and to one or more web sites on the Internet several times throughout the workshop presentation, allowing product orders to be placed and transacted immediately. The product orders are received by intermediary entity 310 and/or an optional ally entity 312 and product suppliers 320. The product revenue is sent either directly to intermediary entity 310 or to ally entity 312, which in turn sends the revenue minus a commission to product suppliers 320. Alternatively, product revenue can be sent directly to the product suppliers, who in turn pay a commission to intermediary entity 310 upon completion of the order. This creates back-end revenue (via sales commissions) for intermediary entity 310 from products sold during the workshops. The ordered products are then shipped directly to the purchaser by one or more product suppliers 320. In addition, product suppliers 320 can be charged an advertising/participation fee to be represented in the interest-specific community created by the subscription service provided by intermediary entity 310.

D. Campaign Method

The marketing methods of the invention can also be adapted for use in advertising for political campaigns. For example, individuals running for office can employ the inexpensive multimedia format of the invention to obtain a larger block of face-time with voters than is offered by television or any other media. This format will offer the candidate a forum to educate on issues, and explain his/her position on those issues. The production can also serve as a public service tool that will link the viewer to election registration deadlines, requirements, and locations. Advertisements, coupons, or other offers may be integrated into the production to enhance the value to the viewer, or to decrease the cost for the candidate running for office.

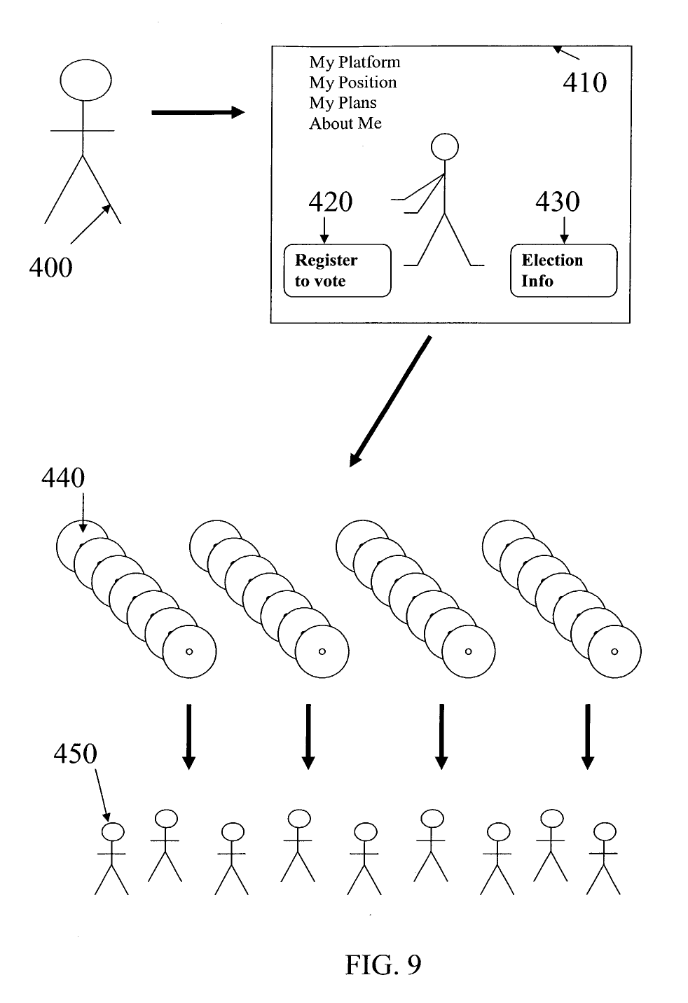

FIG. 9 is a schematic diagram depicting a campaign method of the present invention that can be utilized by a political candidate 400. The content of a presentation can be produced in the manner described previously for viewing on a computer screen 410. The presentation displayed on computer screen 410 can include a button 420 that provides access to online voter registration, as well as a button 430 that provides access to additional election information. In addition, the presentation can include various modules in which the candidate speaks about his or her platform, position on issues, future plans, personal information, etc. The presentation is stored on CD/DVDs 440 and can then be distributed by the candidate to selected voters 450. The voters 450 can view the content of a CD/DVD 440 on their own computers at their own convenience.

E. Other Applications

The multimedia format of the invention can also be used as a general educational platform, or can be tied to a published educational or scholastic book and used as an interactive lab. Throughout the lab, the author (e.g., college professor) can reference passages in the book, and the presentation can provide links to related web sites for specific downloads or other information, or may offer other books or pertinent materials related to the subject matter for purchase over the Internet.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A method for displaying a multimedia presentation on a computer screen, comprising:
producing a plurality of video clips of one or more persons, the video clips having a selected background;
matching the background of the video clips with a background of the computer screen; and
displaying the video clips in a predetermined order at various locations on the computer screen to create the perception that the one or more persons is free to move about the computer screen without being confined to a set area on the computer screen.

2. The method of claim 1, wherein the video clips are produced by filming the one or more persons with a blue or green background.

3. The method of claim 1, wherein the video clips are displayed at locations on the computer screen such that the one or more persons appear to interact with one or more graphical items displayed on the computer screen.

4. The method of claim 3, wherein the graphical items are selected from the group consisting of drawings, photographs, animations, charts, graphs, buttons, icons, words or phrases in text format, and a list or series of items.

5. The method of claim 4, wherein one or more of the graphical items on the computer screen is selectable by a viewer to access different locations in the presentation or to provide access to one or more Internet web sites.

6. A computer product for displaying a multimedia presentation on a computer screen, comprising:
a computer readable medium carrying computer-executable instructions for displaying the multimedia presentation, the computer-executable instructions comprising:
a program module for displaying a plurality of video clips in a predetermined order at various locations on the computer screen to create the perception that one or more persons in the video clips is free to move about the computer screen without being confined to a set area on the computer screen, wherein the background of the video clips matches the background of the computer screen.

7. The computer product of claim 6, wherein the computer readable medium is selected from the group consisting of a compact disc, a digital video disc, and a hard drive.

8. The computer product of claim 6, wherein the video clips are displayed at locations on the computer screen such that the one or more persons appear to interact with one or more graphical items displayed on the computer screen.

9. The computer product of claim 8, wherein the graphical items are selected from the group consisting of drawings, photographs, animations, charts, graphs, buttons, icons, words or phrases in text format, and a list or series of items.

10. The computer product of claim 8, wherein one or more of the graphical items on the computer screen is selectable by a viewer to access different locations in the presentation or to provide access to one or more Internet web sites.

11. The computer product of claim 6, further comprising a program module including a static list of one or more questions for display on the computer screen and a corresponding video clip of a person giving the answer for each question, wherein when a question is selected by a viewer from the list of questions, the video clip of the person appears on the computer screen to give the answer.

12. In a computer system, a computer-readable medium carrying computer-executable instructions for displaying a multimedia presentation, the computer-executable instructions comprising:
a program module for displaying a plurality of video clips in a predetermined order at various locations on a computer screen to create the perception that one or more persons in the video clips is free to move about the computer screen without being confined to a set area on the computer screen, wherein the background of the video clips matches the background of the computer screen.

13. In the computer system of claim 12, wherein the video clips are displayed at locations on the computer screen such that the one or more persons appear to interact with one or more graphical items displayed on the computer screen.

14. In the computer system of claim 13, wherein the graphical items on the computer screen are selected from the group consisting of drawings, photographs, animations, charts, graphs, buttons, icons, words or phrases in text format, and a list or series of items.

15. In the computer system of claim 13, wherein one or more of the graphical items on the computer screen is selectable by a viewer to access different locations in the presentation or to provide access to one or more Internet web sites.

16. In the computer system of claim 12, further comprising a program module including a static list of one or more questions for display on the computer screen and a corresponding video clip of a person giving the answer for each question, wherein when a question is selected by a viewer from the list of questions, the video clip of the person appears on the computer screen to give the answer.

17. In the computer system of claim 12, wherein the program module is stored on a server computer that is accessible by one or more client computers over a computer network.

18. A computer data signal embodied in a carrier wave, comprising:
a program module for displaying a plurality of video clips in a predetermined order at various locations on a computer screen to create the perception that one or more persons in the video clips is free to move about the computer screen without being confined to a set area on the computer screen, wherein the background of the video clips matches the background of the computer screen.

19. A method for producing a multimedia presentation for display on a computer screen, comprising:
making a plurality of video clips of one or more persons, the video clips having a selected background;
matching the background of the video clips with a background of the computer screen;
compiling the video clips with one or more graphical items for display on the computer screen in a presentation such that the video clips are positioned at various locations on the computer screen to create the perception that the one or more persons is free to move about the computer screen and interact with the one or more graphical items without being confined to a set area on the computer screen.

20. The method of claim 19, further comprising storing the presentation on a computer readable medium selected from the group consisting of a compact disc, a digital video disc, and a hard drive.

21. The method of claim 19, wherein one or more of the graphical items on the computer screen is selectable by a viewer to access different locations in the presentation or to provide access to one or more Internet web sites.

22. A method of recruiting one or more persons to join an organization, comprising:
providing a multimedia presentation for display on a computer screen that informs a viewer about the organization;
prompting the viewer during the presentation to access a web site of the organization in order to join the organization;
instructing the viewer to enter a sponsor identification code or number as part of a membership sign-up process at the web site to join the organization; and
placing the membership of the viewer in a pedigree of a sponsor having an identification code or number that corresponds to the identification code or number that was entered by the viewer.

23. The method of claim 22, wherein the presentation is stored in a computer product comprising a computer readable medium carrying computer-executable instructions for displaying the presentation.

24. The method of claim 23, wherein the computer-executable instructions comprise a program module for displaying a plurality of video clips in a predetermined order at various locations on a computer screen to create the perception that one or more persons in the video clips is free to move about the computer screen and interact with one or more graphical items without being confined to a set area on the computer screen.

25. The method of claim 22, wherein the organization is a multi-level or network marketing company.

26. The method of claim 22, wherein the presentation is stored on a server computer that is accessible by one or more client computers over a computer network.

27. A method of generating one or more leads for a service-based organization, comprising:
providing a multimedia presentation for display on a computer screen that informs a viewer about a selected topic;
prompting the viewer during the presentation to access a web site in order to obtain an analysis or evaluation; and
instructing the viewer to enter information as part of a case profile at the web site to generate a lead.

28. The method of claim 27, further comprising placing the lead with one or more service-based organizations.

29. The method of claim 28, wherein the organizations are selected from the group consisting of legal firms, accounting firms, insurance firms, financial planning firms, investment firms, tax preparation firms, and real estate firms.

30. The method of claim 27, wherein the presentation is stored in a computer product comprising a computer readable medium carrying computer-executable instructions for displaying the presentation.

31. The method of claim 30, wherein the computer-executable instructions comprise a program module for displaying a plurality of video clips in a predetermined order at various locations on a computer screen to create the perception that one or more persons in the video clips is free to move about the computer screen and interact with one or more graphical items without being confined to a set area on the computer screen.

32. The method of claim 27, wherein the presentation is stored on a server computer that is accessible by one or more client computers over a computer network.

33. A method of marketing to interest-specific communities, comprising:
providing a multimedia presentation for display on a computer screen that informs an end user about a selected topic;
prompting the end user during the presentation to access one or more web sites to obtain further information or to order one or more products related to the topic; and
transmitting information related to a product order, if one or more products are ordered, to one or more product suppliers for shipment of the product order, with revenue from the product order being sent to an intermediary entity that retains a commission for the product order.

34. The method of claim 33, wherein the presentation is provided on a computer product available to the end user through a subscription service of the intermediary entity.

35. The method of claim 34, wherein the computer product comprises a computer readable medium carrying computer-executable instructions for displaying the multimedia presentation, the computer-executable instructions comprising:
a program module for displaying a plurality of video clips in a predetermined order at various locations on a computer screen to create the perception that one or more persons in the video clips is free to move about the computer screen and interact with one or more graphical items without being confined to a set area on the computer screen.

36. The method of claim 33, wherein the presentation is stored on a server computer that is accessible by one or more client computers over a computer network.

37. A system for marketing to interest-specific communities, comprising:
an intermediary entity having a first contractual relationship with at least one end user, the first contractual relationship having terms whereby the intermediary entity delivers to the end user a computer product for displaying a multimedia presentation about a selected topic in response to receipt of value from the end user; and
the intermediary entity further having at least one supply contractual relationship with at least one supplier entity, the supply contractual relationship having terms whereby the supplier entity provides value to the intermediary entity in response to a product order from the end user.

38. The system of claim 37, wherein the intermediary entity has at least one ally contractual relationship with at least one ally entity, the ally contractual relationship having terms whereby the ally entity delivers value from the intermediary entity to at least one end user.

39. The system of claim 37, wherein the first contractual relationship is based on a subscription service provided by the intermediary entity.

40. The system of claim 37, wherein the value provided by the supplier entity to the intermediary entity is in the form of a commission based on the product order from the end user.

41. A method of campaigning for a political candidate, comprising:
providing a computer product for displaying a multimedia presentation that educates a viewer about the candidate and other selected topics; and
prompting the viewer during the presentation to access one or more web sites to obtain further information on a selected topic.

42. The method of claim 41, wherein the computer product comprises a computer readable medium carrying computer-executable instructions for displaying the multimedia presentation, the computer-executable instructions comprising:
a program module for displaying a plurality of video clips in a predetermined order at various locations on the computer screen to create the perception that the candidate in the video clips is free to move about the computer screen and interact with one or more graphical items without being confined to a set area on the computer screen.
